(19) United States
(12) Patent Application Publication
(10) Pub. No.: US 2024/0033159 A1
(43) Pub. Date: Feb. 1, 2024

(54) POWERED-KNEE EXOSKELETON SYSTEM

(71) Applicant: ABLE HUMAN MOTION, S.L., Barcelona (ES)

(72) Inventors: Pau MARTÍNEZ JIMÉNEZ, Barcelona (ES); Alex GARCIA FARRENY, Barcelona (ES); Pau MOREY OLIVÉ, Barcelona (ES); Alfons CARNICERO CARMONA, Barcelona (ES)

(21) Appl. No.: 18/257,193

(22) PCT Filed: Dec. 14, 2021
(86) PCT No.: PCT/EP2021/085743

§ 371 Date: Jun. 13, 2023

(30) Foreign Application Priority Data
Dec. 14, 2020 (EP) 20383088.0
Dec. 14, 2020 (WO) PCT/EP2021/085743

(51) Int. Cl. A61H 1/02

(52) U.S. Cl. CPC A61H 1/0262; A61H 2003/007

(57) ABSTRACT

The present invention refers to an exoskeleton system to aid in the walking rehabilitation and assistance process of patients. The system comprises: shank segments, thigh segments, a pair of powered knee joints connecting respectively a shank segment and a thigh segment respectively for the left and right legs. A pair of hip joints connect a lumbar segment with the thigh segments, and a pair of foot sole segments are connected with the shank segments. A system controller is adapted for processing angular velocity sensor readings and for controlling the operation of the powered knee joints based on the angular velocity sensors readings. The system controller is further adapted to detect a user's hip thrust gesture indicating a user's intention to initiate a step forward, by detecting an increase in the forward velocity of a hip joint in the direction of walking. The invention provides an intuitive gait experience for users, that closely resembles natural walking.

### FIELD AND OBJECT OF THE INVENTION

The present invention refers to an exoskeleton system to aid in the walking rehabilitation and assistance process of Spinal Cord Injured (SCI) patients, who still preserve some motor function at the hip.

An object of the invention is to provide an exoskeleton system that provides users with an intuitive gait experience, that closely resembles natural walking, without the need to perform unnatural gestures.

An additional object of the invention is to provide an exoskeleton system that reduces undesired motions of the hip joint (i.e., abduction-adduction and internal-external rotation), thereby increasing gait speed and step length, reducing pelvic obliquity, and improving upper-body posture (i.e., reduced trunk inclination).

An additional object of the invention is to provide an exoskeleton system that features a low weight, and that can be easily coupled on patients, and can be easily transported and stored.

### BACKGROUND OF THE INVENTION

The World Health Organization estimates that global spinal cord injury (SCI) incidence is 40 to 80 new cases per million population per year, representing 250,000 to 500,000 cases per annum worldwide. The inability to stand and walk is one of the major consequences of SCI that causes loss of independent mobility and limits community participation and integration. Therefore, gait rehabilitation after SCI has been reported as a high-priority issue for patients independently of their age, time after injury, and lesion severity.

Recovery of ambulation has been identified as one of the highest priorities for SCI patients, however, the level of recovery possible has been reported as being dependent on the neurological level of the lesion and whether the lesion is complete or incomplete. In recent years, technology has evolved to be an important component within a locomotion therapy program. One of the most notable technological developments has been the creation of robotic exoskeletons, with the aim of providing patients with the ability to perform multiple repetitions of the locomotor task with the minimal physical burden to therapists. A high number of repetitions is one of the key principles of motor learning supporting people with incomplete SCI to regain ambulatory functions.

Robotic exoskeletons are devices which are placed over the human body and assist users to perform specific movements. Usually, robotic exoskeletons are equipped with sensors to measure those variables that will help them make decisions and perform tasks at a specific moment. Then, decisions made are transformed into actual movement and force by actuators placed at specific locations depending on the movements the exoskeleton is aimed at restoring.

In particular, wearable lower limb exoskeletons are emerging as a promising solution to restore mobility after SCI due to the active participation required from the user that promotes physical activity, and the possibility of being used as an assistive device in the community.

A small number of exoskeletons have been produced in the past years and are now certified for use in hospitals around the world, whilst there are many others that are either in their early stage of development or are yet to be fully certified for mass use. There are substantial differences between these exoskeletons in terms of their weight, size, orthotic design and method of activation.

Usually, exoskeletons require that users perform weight shifts or unnatural postural cues to initiate the steps. Moreover, the lack of hip control leads to excessive hip external rotation, producing unbalance and undesired leg motions that could eventually lead to injury or fall.

Another important limitation of commercially available solutions that aim to support patients with severe paralysis, is that they are heavy and bulky, thus limiting independent donning/doffing, user acceptance, usability and transportability.

The international PCT Application WO 2018/073252 A1 discloses a system to assist walking in spinal cord injured patients who preserve hip flexion capacity, wherein the system comprises left and right individual orthosis, each one including an angular actuator for each knee, a plurality of sensors, and a control system deciding when to flex or extend the knee depending on the walking cycle and using the sensors data readings. The system does not include a lumbar or hip segment connecting the left and right orthosis.

The PCT publication WO 2013/188868 A1 describes an exoskeleton for applying force to at least one lower limb of a user, comprising: a hip segment; a thigh segment coupled to the hip segment by a powered joint; a plurality of sensors associated with the lower limb; and a control system.

The PCT publication WO 2016/089466 A2 refers to systems and methods for providing assistance with human motion, including hip and ankle motion, wherein sensor feedback is used to determine an appropriate profile for actuating a wearable robotic system to deliver desired joint motion assistance.

### SUMMARY OF THE INVENTION

The present invention is defined in the attached independent claim, and satisfactorily solves the drawbacks of the prior art, by providing a bilateral robotic exoskeleton system for aiding Spinal Cord Injured (SCI) patients with their walking rehabilitation and assistance process, provided that the patients preserve some motor function at the hip, such that the system assists patients in the performance of common manoeuvres that patients may have difficulty with, providing an intuitive gait experience that closely resembles natural walking.

More in detail, an aspect of the invention refers to an exoskeleton system that comprises: a lumbar segment, a pair of shank segments and a pair of thigh segments adapted to be worn by a patient respectively on the lumbar area, shank and thigh parts of the legs.

Having a lumbar segment connected with the thigh segments, reduce undesirable hip rotations and improve walking performance for people with SCI.

The system further comprises a pair of powered knee joints or articulations connecting respectively a shank segment and a thigh segment, to produce a flexion and extension motion between the shank and thigh segments. Preferably, the powered knee joints are adapted to obtain readings of flexion angles between the shank and thigh segments to which are connected.

Additionally, the system comprises a pair of hip joints connecting the lumbar segment with the thigh segments. The pair of hip joints can be either passive joints or active joints. In a preferred embodiment of the invention, the pair of hip joints are passive joints, that allow free flexion and extension relative movement between the thigh segments and the lumbar segments, restricting the other hip degrees of freedom.

The system further comprises a pair of foot sole segments connected with the shank segments either by means of: a passive joint or by means of a fixed joint that constrains the ankle joint to remain fixed at its anatomical configuration.

The above-defined structure of the exoskeleton system allows hip flexion-extension, but restricts hip abduction-adduction and internal-external rotation, such that gait performance is increased, as well as: gait speed and step length, reduced pelvic obliquity, and improved upper-body posture (i.e., reduced trunk inclination) while promoting the process of neuroplasticity.

The system further comprises a pair of sensors arranged to measure the angular velocity of each of the thigh segments, and a system controller adapted for processing angular velocity sensor readings and for controlling the operation of the powered knee joints based on the angular velocity sensors readings.

According to the invention, the system controller is further adapted to detect a user's hip thrust gesture indicating a user's intention to initiate a step forward, by detecting an increase in the forward velocity of a hip joint in the direction of walking.

The system controller is further adapted to operate the respective powered knee joint to perform a knee flexion-extension trajectory to swing a user's leg forward to carry out a step, when an increase in the velocity of the corresponding hip joint has been detected.

Furthermore, the system controller is adapted to operate the powered knee joint to keep a user's leg straight when it is detected that the foot is in contact with the ground.

Preferably, the system controller is adapted to determine the increase in the velocity of a hip joint, by detecting a local minimum value of a thigh segment angular velocity, and comparing the detected local minimum value with subsequent measured angular velocity values, to detect when the difference between the compared values is higher than a predefined threshold.

Therefore, a technical effect and advantage of the invention is its capacity of anticipating a user's intention to initiate a step for walking, without the need for the user to carry out unnatural gestures. This detection of user's intention to initiate a step is detected independently and seamlessly at each step, allowing the user to feel that he/she is in complete control of the exoskeleton while walking.

In addition, the system is capable of assisting patients in manoeuvres like: Sit-to-Stand, Standing, Walking and Stand-to-Sit. The exoskeleton system of the invention is intended to perform ambulatory functions in rehabilitation institutions, with the use of walking aids, and under the supervision of a trained therapist.

Preferably, the system comprises left and right push-buttons for a therapist to manually indicate the system when to initiate the right and left knee flexion-extension trajectory, allowing the user's leg to swing forward to carry out a step. The system is further adapted to store the time instant indicated by the therapist to initiate right and left knee extension trajectory.

Furthermore, the system controller is further adapted to carry out a calibration process to personalize the detection of the hip thrust gesture to each user, by varying the predefined angular velocity threshold, based on the manual activation of the left and right push-buttons and the readings of the thigh or shank segments angular velocity, such that the timing for initiating a knee flexion-extension trajectory substantially match the timing indicated by the therapist.

Furthermore, the system controller is further adapted to perform a safety control to enable or disable the operation of the powered knee joints to swing a user's leg, and wherein the system controller is further adapted to calculate the difference between the angles of both thigh segments with respect to the vertical, such that when that difference is below a predefined safety threshold, the system controller disables the operation of the powered knee joints to swing a user's leg forward.

The system controller additionally adapted to calculate the difference between the angular orientation of a right and left shank segments, as the sum of the angular orientation of each thigh segment and the flexion of the knee.

Additionally, the system controller is adapted to disable the operation of the powered knee joints to swing a user's leg forward, when any one of the powered knee joints is executing a step movement.

Furthermore, the system controller is additionally adapted to enable the operation of the powered knee joints to swing a user's leg forward, when the difference between the angular orientation of the shank segments is higher than the predefined safety threshold and for more than a predefined time.

In addition to the angular velocity sensors, the system includes orientation sensors arranged to measure each thigh segments angle with respect to the vertical to the ground.

The system incorporates at least one inertial measuring unit, IMU, enclosed within the thigh segments and oriented longitudinally, that is, in the femoral direction of the thigh segments, for measuring acceleration, angular velocity and absolute angle of orientation of the thigh segments.

Each IMU unit has nine degree-of-freedom movement sensors, each sensor having a 3-axis gyroscope, a 3-axis accelerometer, and a 3-axis magnetometer, that are used for measuring orientation and acceleration of each leg, generating absolute orientation, angular velocity and linear acceleration readings.

In a preferred embodiment, the exoskeleton is embodied as a modular equipment. In particular, the system comprises five couplable modules, namely: a lumbar module that includes the lumbar segments and the passive free joints coupled to two ends of the lumbar segments, left and right foot segments, and left and right leg modules each one including a shank segment, a thigh module and a powered knee joint. It also presents a modular design to ease transportation, storage in a suitcase and the processes of donning and doffing.

Therefore, an unlike prior art exoskeleton that use four or six motors to operate, according to the invention, with only two motors at the knees and restricting other movements preferably in a passive way, a patient with complete paraplegia (no motor function below the hip) is capable of walking again.

Using only two actuators in the knees, the system of the invention is able to help paraplegic patients standing up and walking, maximizing user participation in walking by promoting the preserved motor functions and only actuating in the knee joints, without assisting unnecessary movements. Flexion of the knee allows lowering the hip during the swing phase, which reduces oscillations of the centre of mass, improving the energy efficiency of the gait.

### BRIEF DESCRIPTION OF THE DRAWINGS

Preferred embodiments of the invention are henceforth described with reference to the accompanying drawings, wherein:

FIG. 1.—shows in a perspective view, a preferred implementation of the exoskeleton system of the invention in a standing position.

FIG. 2.—shows in Figures A and B, two perspective views of the exoskeleton in two different walking positions.

FIG. 3.—shows two elevational views of the exoskeleton, Figure A is a front elevational view and Figure B is a rear elevational view.

FIG. 4.—shows another perspective view of the exoskeleton in use assisting a patient in walking.

FIG. 5.—shows in a perspective view, the modular construction of the exoskeleton.

FIG. 6.—shows two perspective views of the lumbar module.

FIG. 7.—shows two graphs corresponding to a healthy gait during three steps period, wherein Figure A shows a shank segment flexion while walking, and in FIG. B the corresponding shank segment velocity. Shank flexion refers to the angle that a shank segment has with respect to the vertical. Units are not relevant but positive in this context is equivalent to the heel pointing back. Toe Off event is marked for each step.

FIG. 8.—shows two graphs corresponding to an SCI gait using the exoskeleton of the invention during three steps period, and in correspondence with the graphs of FIG. 7. Similarly to FIG. 7, Figure A shows a shank segment flexion while walking, and in Figure B the corresponding shank segment velocity. Shank flexion refers to the angle that a shank segment has with respect to the vertical. Units are not relevant but positive in this context is equivalent to the heel pointing back. Toe Off event is marked for each step.

FIG. 9.—shows in Figure A an enlarged view of a part of FIG. 7B corresponding to a step. FIG. 9B shows the difference between the “Depth” and “Prominence” values.

FIG. 10.—shows a flow chart of the safety control process.

### PREFERRED EMBODIMENT OF THE INVENTION

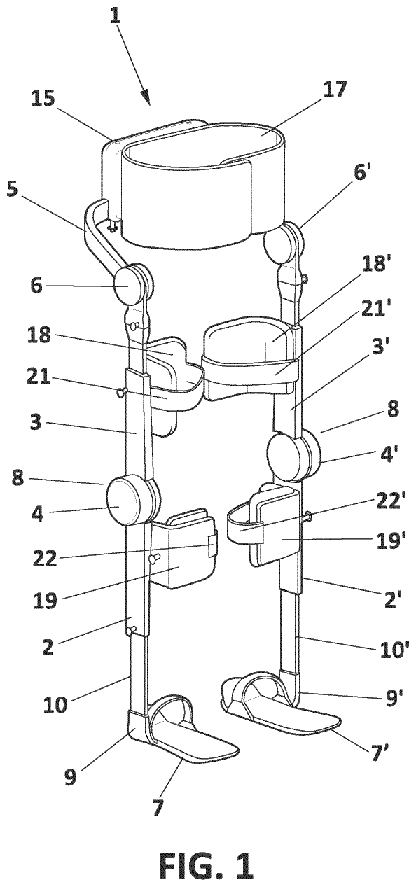

FIGS. 1 to 4 show an exemplary implementation of the exoskeleton system (1) of the invention, that comprises a pair of shank segments (2,2′), a pair of thigh segments (3,3′) and a pair of powered knee joints (4,4′) connecting respectively a shank segment (2,2′) and a thigh segment (3,3′), to produce a controlled flexion and extension motion between the shank and thigh segments (2,2′,3,3′) for the left and right leg of a patient.

Each powered knee joint (4,4′) includes an electric motor (not shown) associated to a gear mechanism (not shown) to increase motor's torque. The electric motor and gear mechanism are enclosed within a cylindrical casing (8,8′).

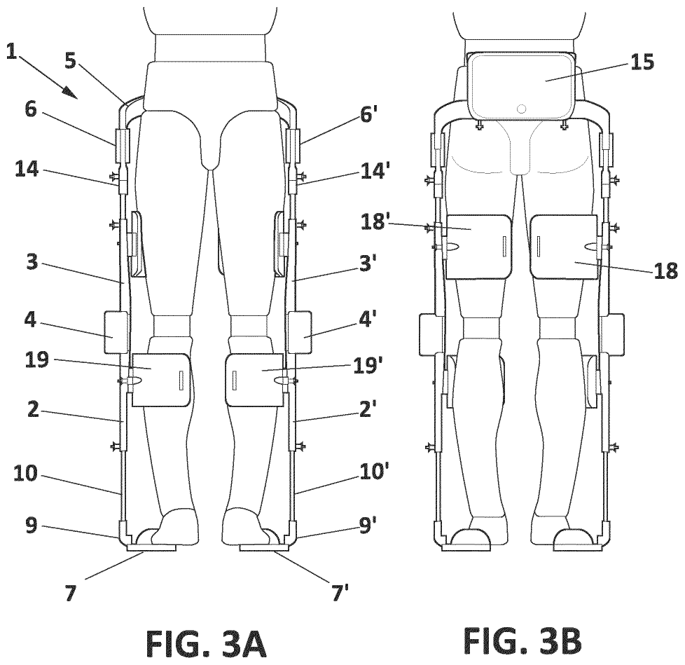

Shank and thigh segments (2,2′,3,3′) are constructed as straight and flat rigid bodies, made of lightweight material like aluminium, carbon fiber, and/or hard plastic. As shown in FIGS. 3A,3B the exoskeleton has a very thin and light construction that facilitates its portability and usability, while enabling an easy transfer of a patient from a wheelchair. In particular, as shown in FIGS. 3A,3B shank and thigh segments are coplanar, that is, they move relative to each other on the same plane. The exoskeleton has no backpack or upper body components, which together with its compact design allows it to be worn while seated in a standard wheelchair.

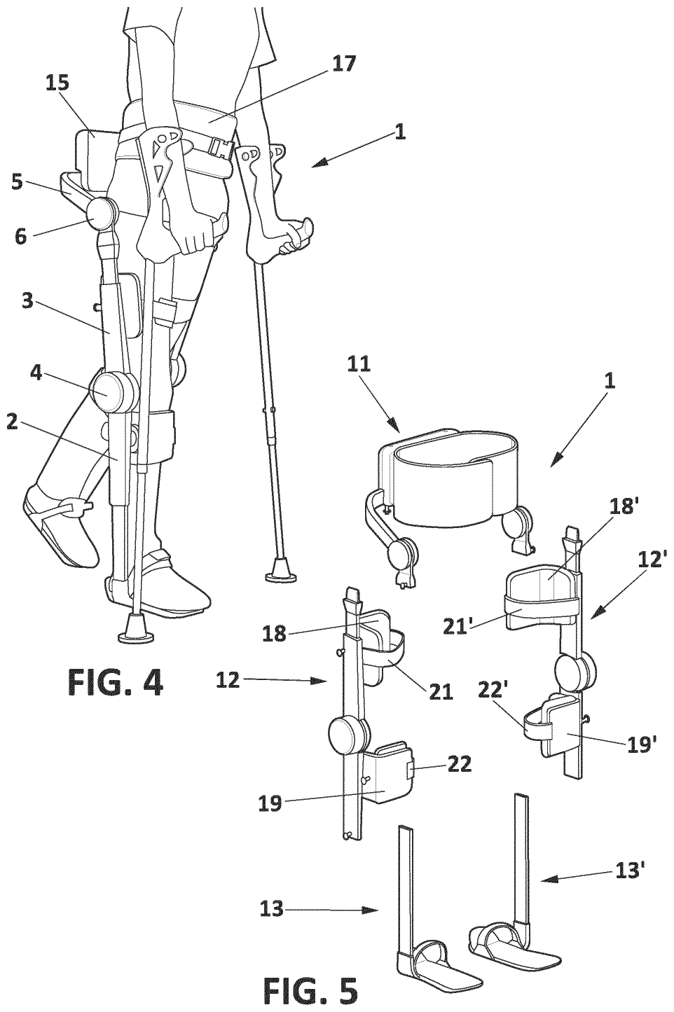

The system (1) further comprises a lumbar segment (5) having generally a U-shaped configuration, and anatomically adapted to be coupled at the hip and lumbar area of a patient, as shown for example in FIGS. 3 and 4. The lumbar segment (5) is also constructed as a flat body made of lightweight material, and it incorporates a strap (17) or belt for firmly attaching the same to a user's lumbar area as shown in more detail in FIG. 4.

Similarly, each thigh segment (3,3″) is fitted with a thigh support (18,18″) provided with thigh straps (21,21″), and each shank segment (2,2″) is fitted with a shank support (19,19″) provided with shank straps (2,2″), for respectively supporting and attaching thigh and shank segments to the corresponding parts of a user's leg and right legs.

The system further includes a pair of hip joints (6,6″) connecting the lumbar segment (5) at its ends with the thigh segments (3,3″). In this exemplary implementation, the pair of hip joints (6,6″) are passive joints, that allow free flexion and extension relative movement between the thigh segments (3,3″) and the lumbar segment (5). However, in other practical implementations, the hip joints (6,6″) are embodied as active joints.

Additionally, a pair of foot sole segments (7,7″) is connected with the shank segments (2,2″), in this preferred implementation, by means of respective fixed joints (9,9″) that constrains the ankle joint to remain fixed at its anatomical configuration to impede user's ankle movement.

The position of the foot sole segments (7,7″) is longitudinally adjustable with respect to the shank segments (2,2″). For that, each foot sole segments (7,7″) includes a bar (10,10″) that is telescopically couplable with the respective shank segments (2,2″), and is provided with quick-release locking pins, to fix the foot sole segment with the respective shank segment in the desired position.

The hip width, thigh length and depth, shank length and depth, and heel stop depth are easily adjustable without any external tools by using quick-release locking pins, and are designed such that the exoskeleton can be used by people weighing up to 100 kg and a height between 150 and 190 cm.

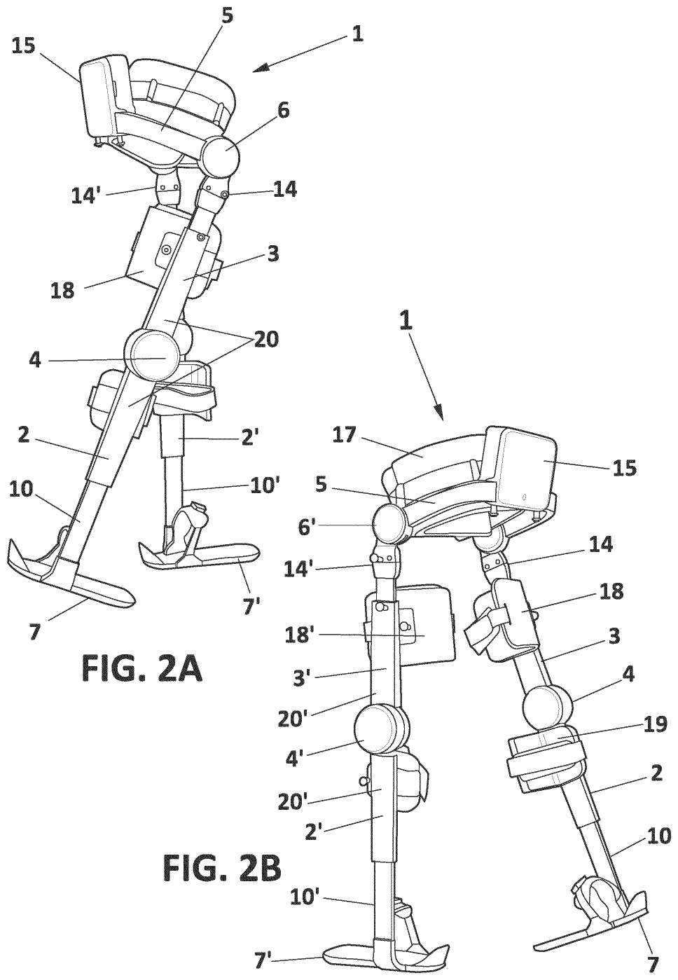

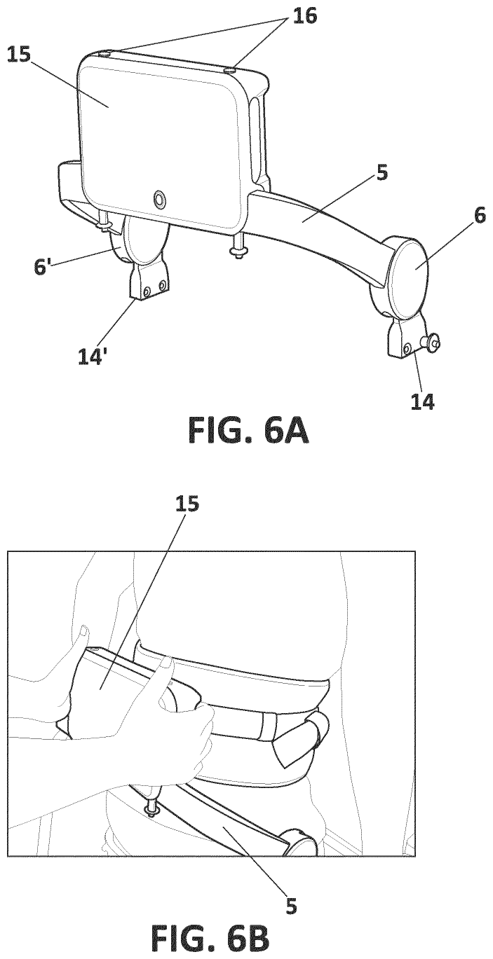

As represented more clearly in FIGS. 2B, 6A, and 6B, the lumbar segment (5) has a casing (15), which encloses a battery component and an Electronic Control Unit, ECU, and preferably also a Wi-Fi and Bluetooth communication modules. Additionally, the casing (15) is configured to be used as hand holders for a therapist to help a user to maintain balance as illustrated in FIG. 6B.

A pair of push-buttons (16) are provided in the casing (15), and are associated with the Electronic Control Unit, ECU, so that a therapist can manually indicate the system when to swing user's left and right legs forward to carry out a step, such that the system controller can carry out the calibration process previously explained. In addition to trigger manual steps, the push-buttons (16) can be used to trigger other transitions like stand up process and sit down process.

While standing, the actuator of the powered-knee joints applies the necessary torque to hold the user's legs straight. To detect the user's intention to move forward, the on-board ECU in the lumbar segment (5) receives motion data from the IMU sensors placed at the thigh segments (3,3″) caused by hip movements, analyses the data and identifies the time instant at which a knee flexion-extension cycle must be triggered to swing a leg forward, mimicking the trajectory of a natural gait. Auditory feedback and visual cues from LED lights on the lumbar segment inform both the therapist and the user of the system status and operating state.

As shown in FIGS. 2A,2B, the IMU units (20,20″) are preferably integrated inside the thigh segments (3,3″), right above the powered-knee joints (4,4″). Alternatively, the IMU units (20,20″) are placed at the shank segments (2,2″), right below the powered-knee joints (4,4″).

The exoskeleton is to be used with a cane, crutch or walker for stability as represented in FIG. 4, and if required, the therapist can help the user to keep balance by holding the casing (15) with both hands as shown in FIG. 6B, and the pair of push-buttons (16) are placed on a way that they can be reached by the therapist's fingers without moving his hands while holding the casing (15).

As represented in FIG. 5 the exoskeleton system (1) is constructed as a modular apparatus, in a way that it comprises five couplable modules, namely: a lumbar module (11) formed by the lumbar segment (5) and the passive free joints (6,6″) each one coupled to an end of the lumbar segment (5), left and right leg modules (12,12″) each one including a thigh segment (3,3″) a shank segment (2,2″) and the corresponding powered-knee joint (4,4″), and finally a foot modules (13,13″) that includes a foot segment (7,7″) and a bar (10,10″).

For connecting the lumbar module (11) with the left and right leg modules (12,12″), the system (1) is fitted with fast connection means (14,14″) for coupling the modules together mechanically and electrically for connecting the batteries and ECU with the IMU units arranged at the thigh segments (3,3″) and the electric motor of the knee joint (4,4″).

For using the exoskeleton, the modules are first fitted individually to the corresponding body parts, and then they are connected together. This modularity provides unique usability by reducing substantially the time to put on and off the device. This feature, together with a compact and slim structure that is positioned closest to the user's body, enables to put on and off the exoskeleton directly from a wheelchair, thus avoiding unnecessary transitions to a chair. It also offers ease of handling, transportation, and storage in a small suitcase.

Preferably, the casing (15) also encloses a Wi-Fi and Bluetooth communication module, so that by means of a mobile phone application, it allows the therapist to configure (fit properly to the user, show system status), operate (transition between operating states, change gait parameters such as knee flexion or swing phase time in real-time) and monitor (real-time utilization, track user's progress, record sessions' data) the exoskeleton during a therapy session.

The system incorporates an add-on for advanced users: a remote controller (not shown) that can be attached to the cane, crutch or walker to allow users to transition between operating states independently. The remote controller communicates wirelessly to the exoskeleton via Bluetooth and provides visual and auditory system status feedback. Thus, the user can stand up, walk, and sit down on their own, always with the supervision of a therapist.

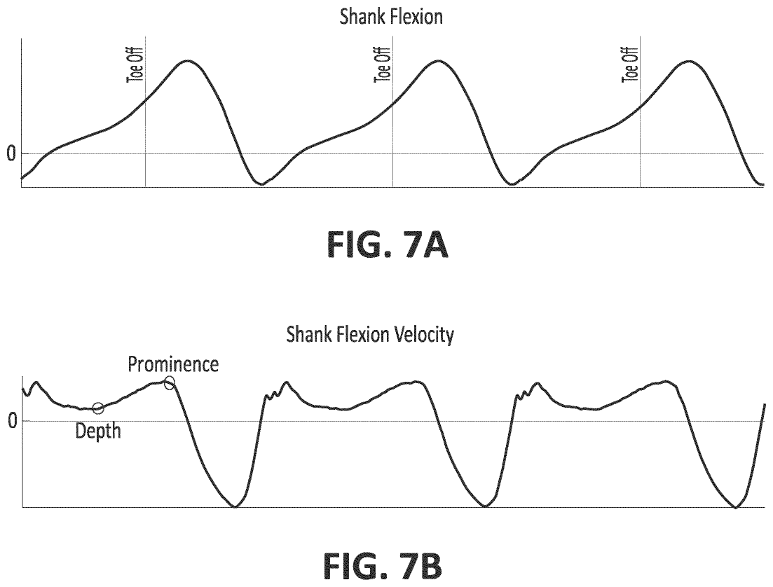

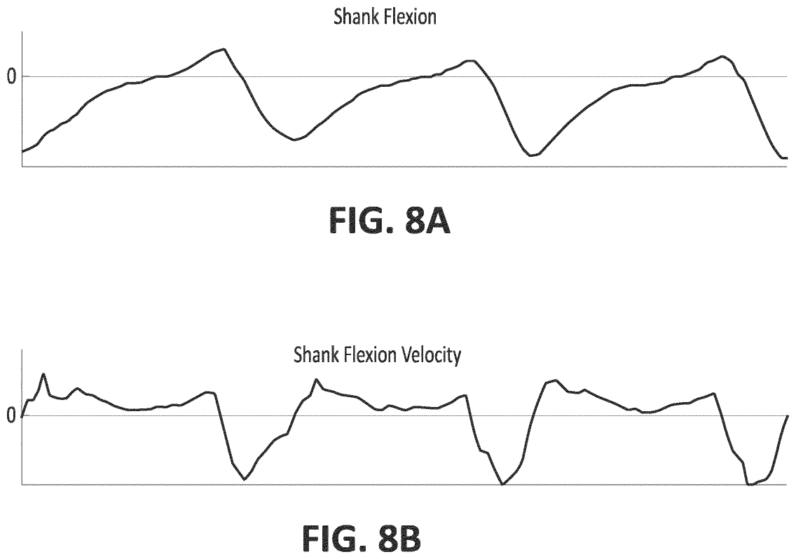

FIGS. 7 and 8 illustrate the control process carried out by the system controller. As shown in these figures, around the Toe Off event in each step, that is, when the user lifts the foot off the ground, the angular velocity of the shank rises from a local minimum regarded as “Depth” to a maximum value regarded as “Prominence”.

In the invention, it has been found that by detecting these two critical points, “Depth” and “Prominence”, is equivalent to detecting a “Hip thrust” forward when an SCI patient uses the bilateral exoskeleton, and this detected “Hip thrust” is the gesture considered as the intention of a patient to initiate each of the steps.

When a user, especially an SCI patient, uses a walker to step forward, it does so by first thrusting the hips forward before raising the feet off the ground. Therefore, detecting the “Hip thrust” is equivalent to detecting the patient's intention to initiate a step. The “Hip Thrust” can be defined as a sudden increase in the forward velocity (in the direction of walking) of the hip joint during the double support phase of walking.

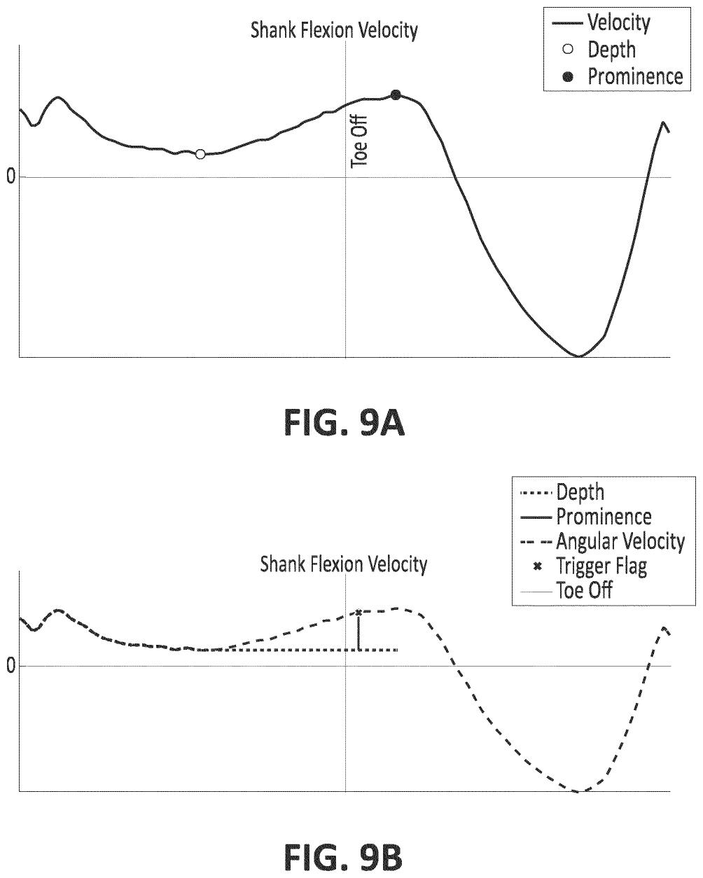

FIG. 9A shows an enlarged view of a shank flexion corresponding to one step, wherein the “Depth” and “Prominence” values are indicated, and FIG. 9B shows the difference between the Depth” and “Prominence” values. The core calculation process carried out by the system controller is as follows: first, the minimum value of the angular velocity is measured and store it as a “Depth” value. Secondly, the stored “Depth” value is compared against the actual measured angular velocity. Both will be equal while the angular velocity is decreasing, but once the local minimum is found, the actual velocity will increase. Once the difference between actual velocity and depth is greater than a predefined threshold (Prominence), the “Hip Thrust” has been detected and a step motion should be triggered to operate the respective powered-knee joint to swing a user's leg forward.

Therefore, the core calculation process minimum function requires:
One variable to store the Depth
One Adjustable parameter, Prominence
The readings of the Angular Velocity sensor

Above this core calculation process, the system controller is adapted to implement a safety control to enable or disable the execution of the core calculation process, thus, enabling or disabling the operation of the powered knee joints.

In this safety control, the system controller calculates the difference between the angles of both thigh segments with respect to the vertical, such that when that difference is below a predefined safety threshold, the system controller disables the operation of the powered knee joints to swing a user's leg forward.

The core calculation is reset every time a step is finished or when the thigh angle becomes negative. This ensures the swing part of the step is ignored and increases robustness when starting a walk.

The safety control uses the thigh angle to prevent the algorithm from being executed unless the legs are separated longitudinally more than a predefined threshold. This is calculated as the difference of the thigh angles with respect to the vertical. Any angle difference between legs below the given threshold disables the trigger for safety. It also controls when the core needs to be reset.

The safety control minimum parameters are the following:
The measurement of the thigh angle with respect to the vertical of both braces.
1 Parameter that controls the minimum separation to enable the core.
1 Parameter that controls the Straight Legs knee flexion.

This is set up as a series of IF statements prior to the core functionality that disables the core in the following circumstances.
If the separation between legs is less than the predefined threshold, the core is disabled.
If the thigh angle becomes negative (Heel pointing forward) the Core is reset, clearing its memory.
If the flexion angle of the knee is different from the predefined Straight Legs knee flexion, the core is disabled.

The complete process requires:
Measurement of the angular velocity of each thigh.
Measurement of the angle with respect to the vertical of each thigh.
1 Variable to store the Depth.

And is adjusted with:
1 Primary parameter, Prominence
2 Secondary parameters:
   Leg minimum separation
   Straight Legs knee flexion

The secondary parameters are defined such that can be set at the beginning of the session and do not need to be changed much. The core parameter, however, usually needs to be adjusted to the current state of the patient and will change when the user gets comfortable with the device and the rehabilitation advances.

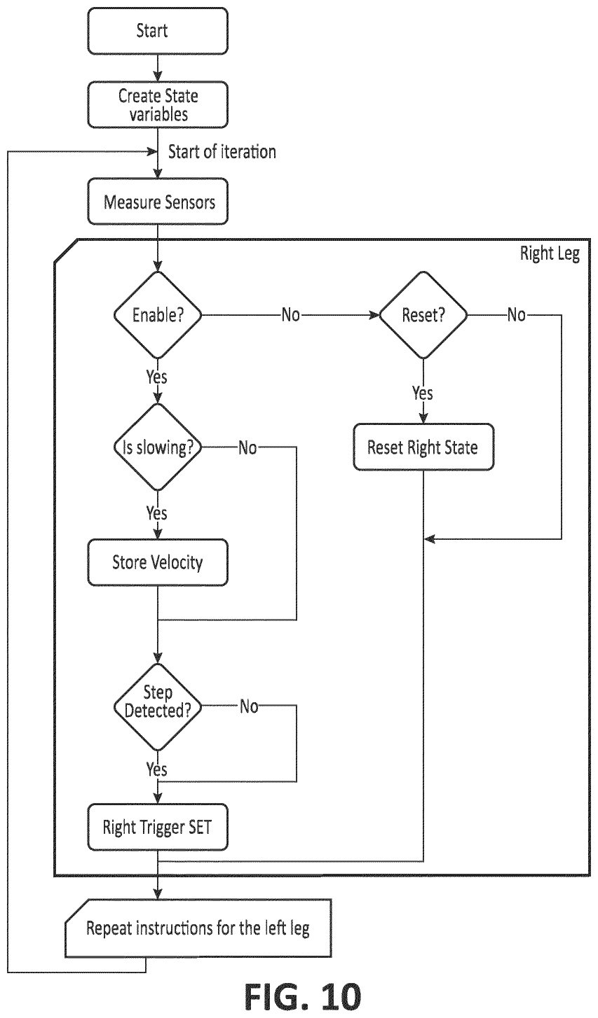

On a higher level, the algorithm is executed at every timed interval and performs the tests in FIG. 10. Each block in the flowchart diagram represents a function that is called and either modifies the state or returns a condition pass or fail.

The exoskeleton system operation is adapted to each user automatically, running a calibration process that oversees the data measured and adjusts the parameters to the adequate value for functioning. The calibration may be run in parallel to the data acquisition or in series. Parallel or “Live calibration” is executed alongside the core process and it adjusts the parameters after each step is taken.

In a preferred embodiment, the calibration process is executed in series, after a set of steps is taken, the calibration optimizes the parameters after the steps are taken to not disturb the user of the exoskeleton while it is in direct use.

To initiate the calibration process, a second user, usually a therapist, uses the push-buttons (16) at the casing (15) to trigger steps manually.

The workflow is as follows
Calibration is activated
The exoskeleton starts storing the data.
The user and the therapist perform the maximum steps possible using the Manual Mode.
The exoskeleton processes the data
The parameters are adjusted.

This workflow allows for independent measurement of data. It is assumed that the therapist knows the correct timing to trigger a step and therefore the walking algorithm does not influence the data for the calibration. This information can be then used to recommend the parameters that would result in gait patterns similar to the patterns recommended by the therapist.

The data measured is the following:
Time
L/R thigh angular velocity
Leg angle difference
L/R Stepping State (1 while the knee is performing a flexion or an extension, 0 otherwise).

The Calibration process mainly depends on the data process pipeline, consisting of several steps that extract the relevant points from the data to compute the parameters.
1. Filter: L/R angular velocities are filtered to smooth out noise and unintended peaks.
2. Crop: The data is shortened to include only the period of consistent steps.
3. Minimum Leg Separation Estimation
4. Prominence Estimation.

In step 3, Minimum Leg Separation Estimation recommends a value for the Minimum Leg Separation that ensures that the triggered steps by the therapist are allowed. It achieves this by storing the Leg Separation at the moment of each trigger.

The recommended value will be the average minus 2 times the standard deviation. This ensures that 95% of the theoretical distribution of steps is triggered. This value is then clamped by a minimum value set by default to exclude extremely small values that should not be allowed for safety reasons.

In Step 4, Prominence estimation recommends a value for the Prominence that will trigger the majority of steps of the data distribution. It achieves it by first detecting when a step has been triggered, then measuring backwards the absolute prominence and absolute depth.

The successful steps are computed by classifying the minimums of the thigh angular velocity. It is considered that a step is successful if it generates a minimum with a value lower than 100 deg/s (3 Lowest minimums in FIG. 8).

For each peak, iteration is performed to look for the Prominence (FIG. 8). If the Prominence is found, the iteration is continued to find the next minimum, the Depth. When the two values have been found, the recommended Prominence is stored (FIG. 9B).

The recommended value will be the mean Prominence minus two times the standard deviation. This ensures that 95% of the theoretical distribution of steps is triggered. This value is then clamped by a minimum value set by default to exclude extremely small values that should not be allowed for safety reasons.

Those recommended values are stored into the walking profile of each particular user. This process allows personalizing the gait trigger algorithms to each individual, detecting seamlessly their intention to initiate each step by interpreting the minimal movements produced by the user. This allows the user to skip trial and error and focus on the therapy and focusing their efforts in generating healthy gait patterns.

Other preferred embodiments of the present invention are described in the appended dependent claims and the multiple combinations of those claims.

1. A powered-knee exoskeleton system, comprising:
a pair of shank segments,
a pair of thigh segments,
a pair of powered knee joints connecting respectively a shank segment and a thigh segment, to produce a flexion and extension motion between the shank and thigh segments,
a lumbar segment,
a pair of hip joints connecting the lumbar segment with the thigh segments,
a pair of foot sole segments connected respectively with the shank segments,
at least a pair of sensors suitable to measure or calculate angular velocity of each of the thigh or shank segments,
a system controller adapted for processing angular velocity sensor readings and for controlling the operation of the powered knee joints abased on the angular velocity of the sensors readings,
wherein the system controller is further adapted to detect a user's hip thrust gesture indicating a user's intention to initiate a step forward, by detecting an increase in the forward velocity of a hip joint in the direction of walking, and
wherein the system controller is adapted to determine the increase in the forward velocity of a hip joint in the direction of walking, by detecting a local minimum value of the thigh or shank segment angular velocity, comparing the detected local minimum value with subsequent measured angular velocity values, to detect when the difference between the compared values is higher than a predefined threshold and resetting the user's hip thrust gesture detection every time the thigh or shank angle becomes negative.

2. The system according to claim 1, wherein the system controller is further adapted to operate the respective powered knee joint to perform a knee flexion-extension trajectory, allowing the user's leg to swing forward to carry out a step, when an increase in the velocity of a hip joint has been detected.

3. The system according to claim 1, further comprising left and right push-buttons for a therapist to manually indicate the system when to initiate the right and left knee flexion-extension trajectory, allowing the user's leg to swing forward to carry out a step, and wherein the system is further adapted to store the time instant indicated by the therapist to initiate right and left knee extension trajectory.

4. The system according to claim 1, wherein the system controller is further adapted to carry out a calibration process to personalize the detection of the hip thrust gesture to each user, by varying the predefined angular velocity threshold, based on the manual activation of the left and right push-buttons and the readings of the thigh or shank segments angular velocity, such that the timing for initiating a knee flexion-extension trajectory substantially match the timing indicated by the therapist.

5. The system according to claim 1, further comprising orientation sensors arranged to measure each thigh or shank segment angle with respect to the vertical to the ground.

6. The system according to claim 1, wherein the system controller is further adapted to perform a safety control to enable or disable the operation of the powered-knee joints to swing a user's leg, and wherein the system controller is further adapted to calculate the difference between the angles of both thigh or shank segments with respect to the vertical, such that only when that difference is higher than a predefined safety threshold and for more than a predefined time, the system controller enables the operation of the powered-knee joints to swing a user's leg forward.

7. They system according to claim 1, wherein the powered-knee joints are adapted to obtain readings of flexion angles between the shank and thigh segments to which are connected.

8. The system according to claim 7, wherein the system controller is additionally adapted to disable the operation of the powered-knee joints to swing a user's leg forward, when any one of the powered-knee joints is executing a step movement.

9. The system according to claim 1, wherein the pair of hip joints are: passive joints or active joints.

10. The system according to claim 1, wherein the pair of foot sole segments are connected respectively with the shank segments by means of: a passive joint or by means of a fixed joint that constrains the ankle joint to remain fixed at its anatomical configuration to impede user's ankle movement.

11. The system according to claim 1, wherein the position of foot sole segments is longitudinally adjustable with respect to the shank segments length of the thigh and shank segments, and the width of the lumbar segment is telescopically adjustable, and/or wherein the position of each adjustment can be changed manually by means of quick-release locking pins.

12. The system according to claim 1, wherein the system controller is adapted to operate a powered-knee joint to keep a user's leg straight when it is detected that the foot is in contact with the ground.

13. The system according to claim 1, further comprising five couplable modules, namely: a lumbar module formed by the lumbar segment and the passive free joints each one coupled to an end of the lumbar segment, left and right leg modules each one including a thigh segment a shank segment and a powered-knee joint, and left and right foot modules each one including a foot segment and a bar.

14. The system according to claim 1, wherein the lumbar segment has a casing with a battery component and an Electronic Control Unit, ECU, both enclosed within the casing.

15. The system according to claim 5, wherein the system further comprises at least one inertial measuring unit enclosed within the thigh segments, for measuring acceleration, angular velocity and absolute angle of orientation of the thigh segments.

16. The system according to claim 6, wherein the predefined time is greater than or equal to zero.

17. The system according to claim 7, wherein the system controller is additionally adapted to calculate the difference between the angular orientation between both shank segments, as the sum of the angular orientation of each thigh segment and the flexion of the powered knee joint.

18. The system according to claim 9, wherein the pair of hip joints are passive joints, that allow free flexion and extension relative movement between the thigh segments and the lumbar segment, and restrict the hip abduction-adduction and the hip internal-external rotation.

19. The system according to claim 13, wherein the system further comprises fast connection means for coupling the modules together, and wherein the fast connection means for connecting the lumbar module with the left and right module, includes an electrical connection.

20. The system according to claim 14, wherein the casing has a pair of hand holders for a therapist to help a user to maintain balance, and push-buttons associated with the Electronic Control Unit.

21. The system according to claim 14, wherein the lumbar module includes a belt or strap for attaching the same to the user's lumbar area.
